(19) United States
(12) Patent Application Publication
(10) Pub. No.: US 2007/0071098 A1
(43) Pub. Date: Mar. 29, 2007

(54) Image storage device for motion estimation and method of storing image data

(75) Inventor: Jae-hun Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/495,586

(22) Filed: Jul. 31, 2006

(30) Foreign Application Priority Data
Sep. 26, 2005 (KR) 10-2005-0089503

(51) Int. Cl. H04N 7/12; H04N 11/04

(52) U.S. Cl. 375/240.12; 375/240.24

(57) ABSTRACT

Provided are an image data storage device included in a motion estimation device to store image data of a reference frame required for motion estimation and a method of storing image data. The image data storage device includes a data storing unit storing search area data of the reference frame used for motion estimation of a macroblock and a controller performing controlling to store the search area data in or read the search area data from the data storing unit. The data storing unit includes at least one internal memory capable of storing a plurality of data units. Each of the data units is search area data of the reference frame having a size corresponding to a difference between search area data used for motion estimation of an i^{th} (i is an integer) macroblock and search area data used for motion estimation of an (i+1)^{th} macroblock.

### CROSS-REFERENCE TO RELATED PATENT APPLICATION

This application claims priority from Korean Patent Application No. 10-2005-0089503, filed on Sep. 26, 2005, in the Korean Intellectual Property Office, the disclosure of which is incorporated herein in its entirety by reference.

### BACKGROUND OF THE INVENTION

1. Field of the Invention

The present invention relates to an apparatus and method for storing image data and, more particularly, to an image data storage device included in a motion estimation device to store image data of a reference frame used for motion estimation and a method of storing image data.

2. Description of the Related Art

Video compression standards such as the moving picture expert group (MPEG)-1, MPEG-2, MPEG-4 Visual, H.261, H.263, and H.264 standards, divide an input image into 16×16 macroblocks. After each of the macroblocks is encoded in each of the interprediction and intraprediction encoding modes available, the bit rates required for encoding the macroblock and the rate-distortion (RD) costs of the various encoding modes are compared. Then an appropriate encoding mode is selected according to the result of the comparison and the macroblock is encoded using the selected encoding mode.

Using interprediction, the motion of a macroblock of a current frame is predicted by referring to a macroblock of a neighboring frame of the current frame to reduce temporal redundant components using similarities between the video frames. In interprediction, motion estimation and motion compensation are performed in units of a macroblock.

Motion estimation involves searching a predetermined area (search area) of a reference frame extending from a position corresponding to a current macroblock to select an area having the smallest difference with the current macroblock as the most similar area and outputting a spatial difference between the most similar area and the current macroblock as a motion vector. Motion compensation involves reading the most similar area from the reference frame using the motion vector obtained through motion estimation and generating an interpredicted block.

In motion estimation, the current macroblock data and the search area data of the reference frame must be read from an external memory device. Because the data of the current macroblock and the search area data are used repetitively in motion estimation of the current macroblock, a motion estimation device includes an internal memory device such as synchronous random access memory (SRAM) to read data required from the external memory device and stores the read data in the internal memory device for use in motion estimation.

In motion estimation, there is a large overlap between the search area data of adjacent macroblocks. Thus, the motion estimation device reads only the search area data of the next macroblock required for motion estimation, not the overlapping search area data. The search area data read from the external memory device is stored in the internal memory device. The internal memory device is divided into several internal memories due to data transmission bandwidth limitations of the internal memory device and for the use of the overlapping search area data. For example, when a macroblock has a size of 16×16, a search area has a size of 144×80, the data transmission bandwidth of the internal memory device is 128 bits, and the number of bits per pixel is 8 bits, the 144×80 pixels of the search area are stored in nine 16×80 internal memories. When the search area data is stored in divided internal memories, the total number of gates of the internal memory device is increased due to an increase in overhead and, thus, the area occupied by the internal memory device also increases. Moreover, as the number of divided internal memories increases, the number of data ports increases and the number of combination logics for multiplexing data read from each internal memory also increases.

Therefore, there is a need for an efficient internal memory included in a motion estimation device to store a reference frame, which is capable of reducing the number of gates and bus access bandwidth.

### SUMMARY OF THE INVENTION

An aspect of the present invention provides an image data storage device which merges divided internal memories, thereby reducing the number of gates and the number of combination logics for multiplexing data read from each internal memory, a method of storing image data, and an image processing device using the method.

Another aspect of the present invention provides an image data storage device capable of reducing the entire processing time without increasing the size of an internal memory, and a method of storing image data.

According to another aspect of the present invention, there is provided an image data storage device included in a motion estimation device to store image data of a reference frame. The image data storage device includes a data storing unit storing search area data of the reference frame used for motion estimation of a macroblock and a controller performing controlling to store the search area data in or read the search area data from the data storing unit. The data storing unit includes at least one internal memory capable of storing a plurality of data units. Each of the data units is search area data of the reference frame having a size corresponding to a difference between search area data used for motion estimation of an i^{th} (i is an integer) macroblock and search area data used for motion estimation of an (i+1)^{th} macroblock.

According to another aspect of the present invention, there is provided an image data storage device included in a motion estimation device to store image data of a reference frame. The image data storage device includes a data storing unit storing search area data of the reference frame used for motion estimation of a macroblock and a controller performing controlling to store the search area data in or read the search area data from the data storing unit. The data storing unit includes at least one internal memories capable of storing a plurality of data units and an additional internal memory storing search area data newly required for motion estimation of the (i+1)^{th} macroblock during motion estimation of the i^{th} macroblock. Each of the data units is search area data of the reference frame having a size corresponding to a difference between search area data used for motion estimation of an i^{th} (i is an integer) macroblock and search area data used for motion estimation of an (i+1)^{th} macroblock.

According to still another aspect of the present invention, there is provided a method of storing image data of a reference frame for motion estimation. The method includes determining a location where search area data used for motion estimation of an i^{th} (i is an integer) macroblock, which is stored in at least one internal memory capable of storing a plurality of data units and is not used for motion estimation of an (i+1)^{th} macroblock, is stored and storing search area data newly required for motion estimation of the (i+1)^{th} macroblock in the determined position of the internal memory. Each of the data units is search area data of a reference frame having a size corresponding to a difference between search area data used for motion estimation of the i^{th} macroblock and search area data used for motion estimation of the (i+1)^{th} macroblock.

According to yet another aspect of the present invention, there is provided a method of storing image data of a reference frame for motion estimation. The method includes determining a location where search area data used for motion estimation of an i^{th} (i is an integer) macroblock, which is stored in at least one internal memory capable of storing a plurality of data units and is not used for motion estimation of an (i+1)^{th} macroblock, is stored, storing search area data newly required for motion estimation of the (i+1)^{th} macroblock in an additional internal memory during motion estimation of the i^{th} macroblock, and storing the search area data newly required for motion estimation of the (i+1)^{th} macroblock, which is stored in the additional internal memory, in the determined position of the internal memories upon completion of motion estimation of the i^{th} macroblock. Each of the data units is search area data of a reference frame having a size corresponding to a difference between search area data used for motion estimation of the i^{th} macroblock and search area data used for motion estimation of the (i+1)^{th} macroblock.

### BRIEF DESCRIPTION OF THE DRAWINGS

The above and other features and aspects of the present invention will become more apparent by describing in detail non-limiting exemplary embodiments thereof with reference to the attached drawings in which:

FIG. 1 is a block diagram of an image processing device according to an exemplary embodiment;

FIG. 2 is a view for explaining motion estimation performed by an image processing unit according to an exemplary embodiment;

FIG. 3 illustrates search area data of a current macroblock and search area data of a next macroblock in motion estimation of the image processing unit according to an exemplary embodiment;

FIG. 4 is a view for explaining data units stored in a data storing unit according to an exemplary embodiment;

FIG. 5 illustrates the structure of a data storing unit according to an exemplary embodiment;

FIG. 6 illustrates the structure of a data storing unit according to another exemplary embodiment;

FIGS. 7A through 7D are views for explaining a process of storing search area data in a data storing unit according to an exemplary embodiment;

FIGS. 8A through 8C are views for explaining a process of storing search area data in a data storing unit according to another exemplary embodiment;

FIG. 9 is a flowchart illustrating a method of storing image data for motion estimation according to an exemplary embodiment; and

FIG. 10 is a flowchart illustrating a method of storing image data for motion estimation according to another exemplary embodiment.

### DETAILED DESCRIPTION OF EXEMPLARY EMBODIMENTS OF THE INVENTION

Hereinafter, the exemplary embodiments of the present invention will be described with reference to the accompanying drawings.

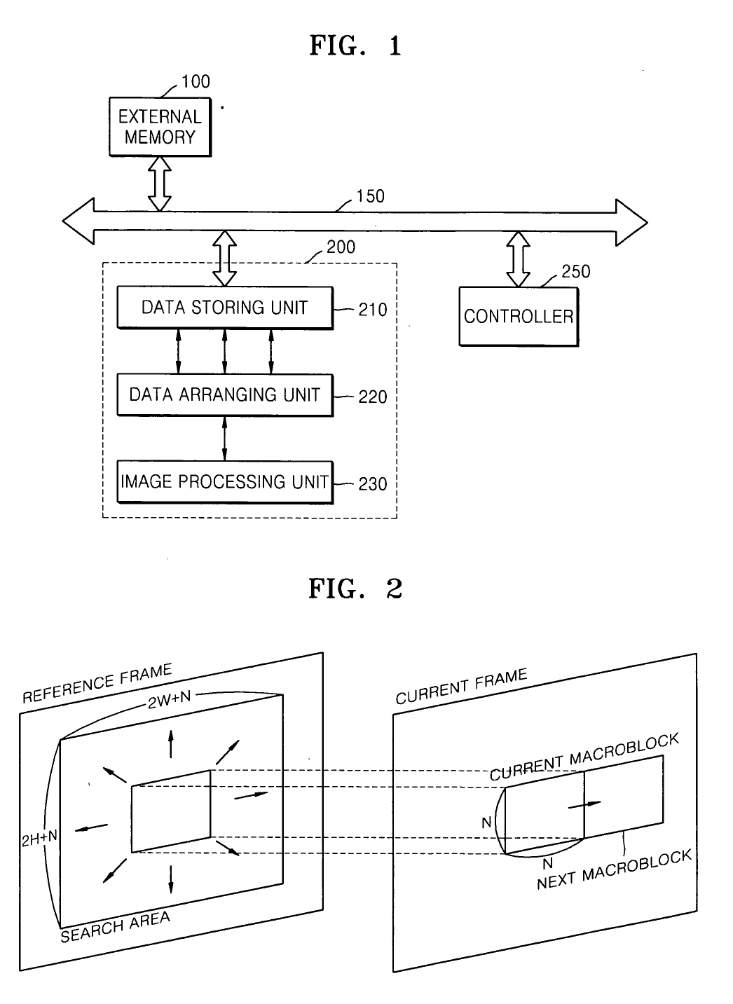

FIG. 1 is a block diagram of an image processing device according to the present invention.

Referring to FIG. 1, the image processing device includes an external memory 100, an image processor 200, and a controller 250. The external memory 100, the image processor 200, and the controller 250 are interconnected through a system bus 150 for communication. The image processor 200 includes a data storing unit 210, a data arranging unit 220, and an image processing unit 230. The data storing unit 210 stores search area data used for motion estimation of a macroblock, which is included in image data stored in the external memory 100. The data arranging unit 220 arranges search area data read from the data storing unit 210. The image processing unit 230 performs encoding and/or decoding of an image using input image data. The image processing unit 230 encodes an image through motion estimation, motion compensation, discrete cosine transform (DCT), quantization, and entropy-encoding or decodes an image through an inverse process corresponding to the method of encoding. Hereinafter, operations of the data storing unit 210, the data arranging unit 220, and the controller 250 in motion estimation of the image processing unit 230 for encoding or decoding of an image will be described in detail.

FIG. 2 is a view for explaining motion estimation performed by the image processing unit 230 according to the present invention.

Referring to FIG. 2, the image processing unit 230 searches a predetermined area (hereinafter, referred to as a search area) of a reference frame, which extends horizontally by ±W pixels and vertically by ±H pixels from a position corresponding to an N×N current macroblock. In other words, the image processing unit 230 selects an area having the smallest difference with the current macroblock as the most similar area from the search area of (2W+N)×(2H+N) and outputs a spatial difference between the most similar area and the current macroblock as a motion vector. For motion estimation, the image processing unit 230 requests search area data of the reference frame required for motion estimation of the current macroblock to the controller 250.

Upon request from the image processing unit 230, the controller 250 controls an operation of reading (2W+N)×(2H+N) search area data of a reference frame required for motion estimation of the current macroblock from the external memory 100 and storing the read search area data in a predetermined location of the data storing unit 210 or reading search area data in a predetermined location for motion estimation of the current macroblock from the data storing unit 210 and providing the read search area data to the image processing unit 230. In particular, the controller 250 performs controlling to keep storing search area data, which is used for motion estimation of the current macroblock and stored in the data storing unit 210, among search area data used for motion estimation of a previous macroblock. The controller 250 also controls an operation of storing new search area data required for motion estimation of the current macroblock in a location where search area data used for motion estimation of the previous macroblock, which is not used for motion estimation of the current macroblock, is stored.

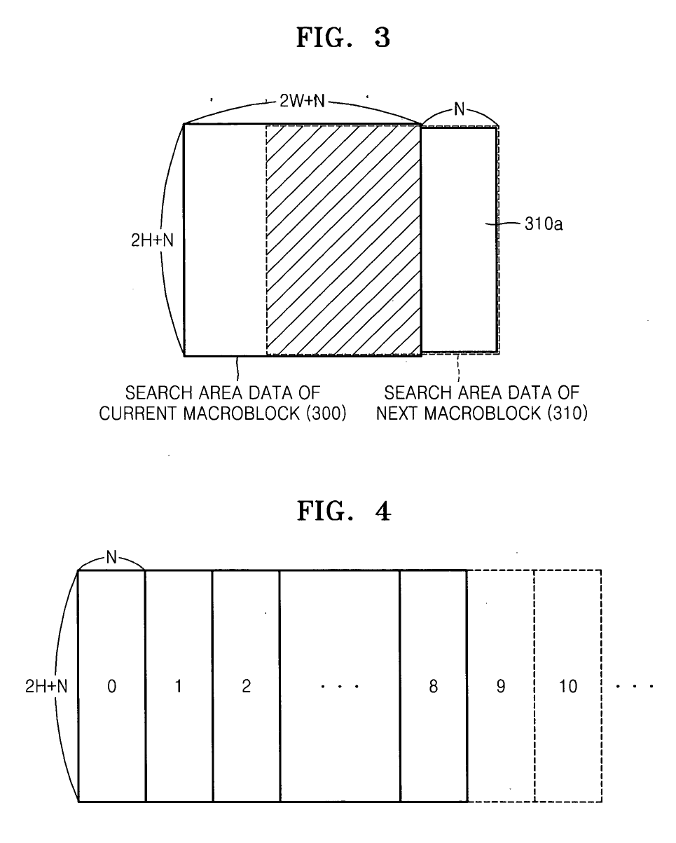

FIG. 3 illustrates search area data of a current macroblock and search area data of a next macroblock in motion estimation of the image processing unit 230 according to this exemplary embodiment of the present invention.

Referring to FIG. 3, according to a raster scan scheme where macroblocks are processed left-to-right and top-to-bottom, search area data 300 of a current macroblock and search area data 310 of a next macroblock have a large overlapping portion. In FIG. 3, a hatched area is an overlapping portion between the search area data 300 of the current macroblock and the search area data 310 of the next macroblock. Thus, in motion estimation of the next macroblock, it is necessary to read only N×(2H+N) search area data 310a excluding the overlapping portion from the search area data 310 of the next macroblock.

FIG. 4 is a view for explaining data units stored in the data storing unit 210 according to this exemplary embodiment of the present invention. In FIG. 4, reference numerals 0 through 10 each indicate a single data unit that is N×(2H+N) search area data having a size corresponding to a difference between search area data used for motion estimation of an i^{th} macroblock and search area data used for motion estimation of an (i+1)^{th} macroblock.

Referring to FIG. 4, when search area data used for processing an i^{th} (i is an integer) macroblock includes the 0^{th} through the 8^{th} data units of FIG. 4, adjacent macroblocks have a large overlapping portion in their search area data used for motion estimation. Thus, among the 1^{st} through the 9^{th} data units required for processing an (i+1)^{th} macroblock, only the newly required 9^{th} data unit is read and existing search area data corresponding to the 1^{st} through the 8^{th} data units from the i^{th} macroblock may be reused.

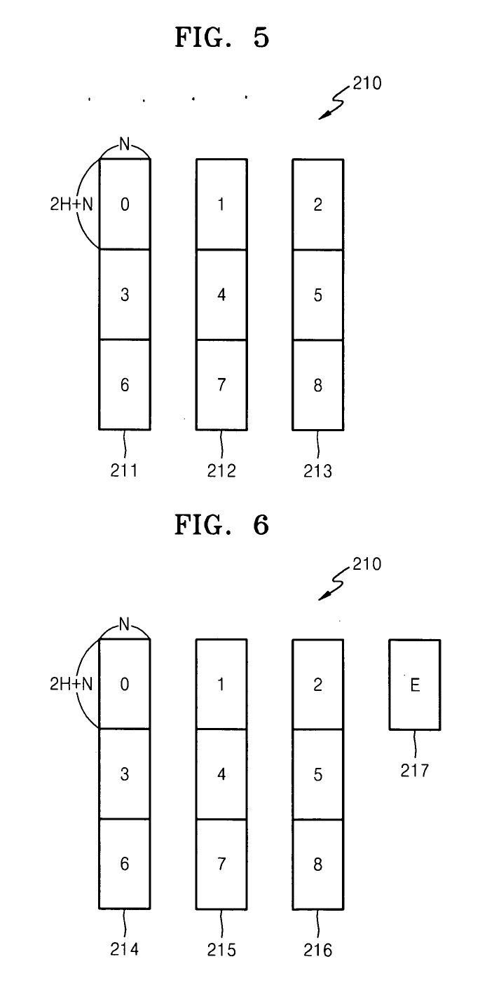

FIG. 5 illustrates the structure of the data storing unit 210 according to an exemplary embodiment of the present invention.

Referring to FIG. 5, the data storing unit 210 according to an exemplary embodiment includes internal memories 211, 212, and 213 capable of storing a plurality of data units. In FIG. 5, each of the three internal memories 211, 212, and 213 include three data units.

As illustrated in FIG. 5, by forming the internal memories 211, 212, and 213 capable of storing a plurality of data units, overhead and the number of gates required for implementing the internal memories 211, 212, and 213 can be reduced. When a macroblock has a size of 16×16, the search area data has a size of 144×80 (W=64, H=32), and a bus access bandwidth is 128 bits, each data unit has a size of 16×80. However, the number of data units stored in each internal memory may be determined based on the bus access bandwidth of the internal memory and the size of the search area data.

FIG. 6 illustrates the structure of the data storing unit 210 according to another exemplary embodiment of the present invention.

Referring to FIG. 6, the data storing unit 210 according to another exemplary embodiment of the present invention includes internal memories 214, 215, and 216 capable of storing a plurality of data units and an additional internal memory 217 for storing newly required search area data for motion estimation of an (i+1)^{th} macroblock during motion estimation of an i^{th} macroblock. The data storing unit 210 according to another exemplary embodiment of the present invention stores search area data required for motion estimation of a next macroblock in the additional internal memory 217 during motion estimation of a current macroblock and stores the search area data stored in the additional internal memory 217 in predetermined locations of the internal memories 214, 215, and 216 when there is no access to the internal memories 214, 215, and 216, thereby reducing a processing cycle. In other words, by forming the additional internal memory 217 in addition to the internal memories 214, 215, and 216 capable of storing a plurality of data units and enabling double buffering, the operating speed of the image processing unit 230 performing motion estimation can be improved.

Hereinafter, an operation of storing search area data in the data storing unit 210 structured as above during motion estimation will be described.

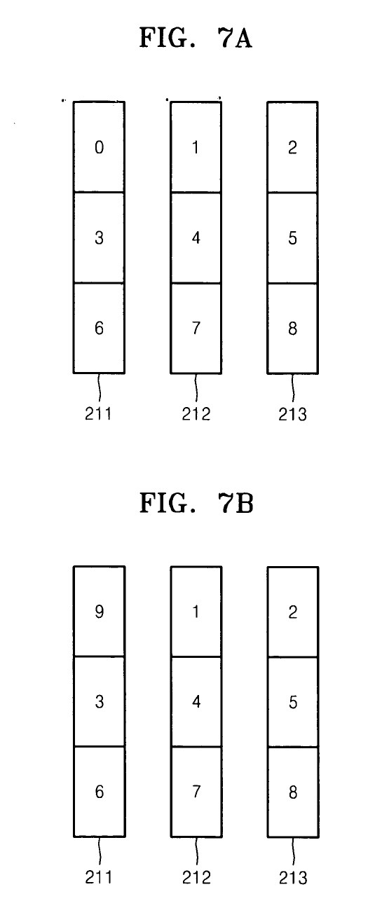

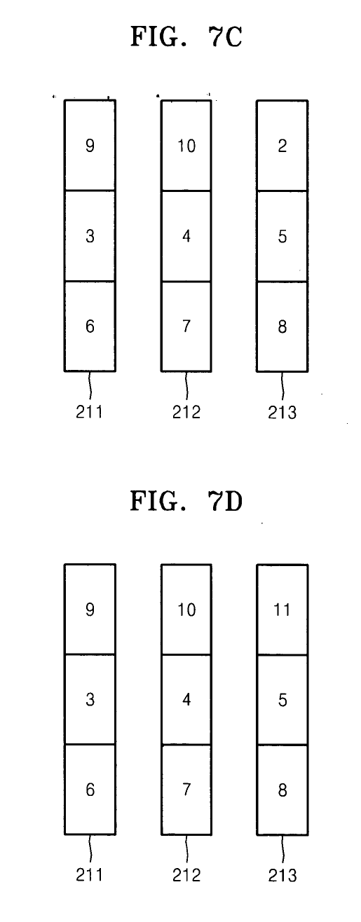

FIGS. 7A through 7D are views for explaining a process of storing search area data in the data storing unit 210 according to an exemplary embodiment of the present invention.

Referring to FIG. 7A, once the image processing unit 230 requests search area data required for motion estimation of an i^{th} macroblock to the controller 250, the controller 250 performs controlling to read the 0^{th} through 8^{th} data units as illustrated in FIG. 4 from the external memory 100 and store the read 0^{th} through 8^{th} data units in predetermined locations of the internal memories 211, 212, and 213 included in the data storing unit 210.

Referring to FIG. 7B, upon completion of motion estimation of the i^{th} macroblock, the image processing unit 230 requests the newly required 9^{th} data unit for motion estimation of an (i+1)^{th} macroblock to the controller 250 and the controller 250 performs controlling to read search area data corresponding to the 9^{th} data unit from the external memory 100 and store the 9^{th} data unit in a location of the internal memory 211 where the 0^{th} data unit is stored. Here, the location where the 0^{th} data unit was stored is not necessary for motion estimation of the (i+1)^{th} macroblock and the 0^{th} data unit may be the left-most data unit of search area data used for motion estimation of the i^{th} macroblock. Similarly, referring to FIGS. 7C and 7D, a 10^{th} data unit newly required for motion estimation of a (i+2)^{th} macroblock and a 11^{th} data unit newly required for motion estimation of a (i+₃)^{th} macroblock are stored in predetermined locations of internal memories where the left-most data units of search area data used for motion estimation of their previous macroblocks are stored.

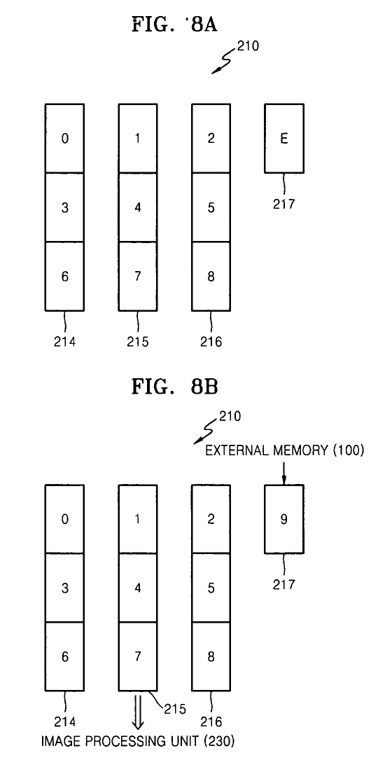

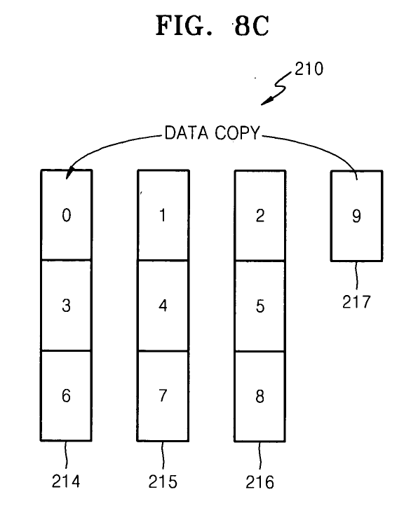

FIGS. 8A through 8C are views for explaining a process of storing search area data in the data storing unit 210 according to another exemplary embodiment of the present invention.

Referring to FIG. 8A, once the image processing unit 230 requests search area data required for motion estimation of the i^{th} macroblock to the controller 250, the controller 250 performs controlling to read the 0^{th} through 8^{th} data units from the external memory 100 and store the read 0^{th} through 8^{th} data units in predetermined locations of the internal memories 214, 215, and 216 of the data storing unit 210.

When the image processing unit 230 performs motion estimation on the i^{th} macroblock, the controller 250 performs controlling to read the 9^{th} data unit newly required for motion estimation of the (i+1)^{th} macroblock from the external memory 100 and store the read 9th data unit in the additional internal memory 217, as shown in FIG. 8B.

When the image processing unit 230 completes motion estimation of the i^{th} macroblock and thus there is no access to the internal memories 214, 215, and 216 storing search area data for motion estimation of the i^{th} macroblock, the controller 250 performing controlling to store the 9^{th} data unit stored in the additional internal memory 217 in a location of the internal memory 214 where the 0^{th} data unit is stored, as shown in FIG. 8C.

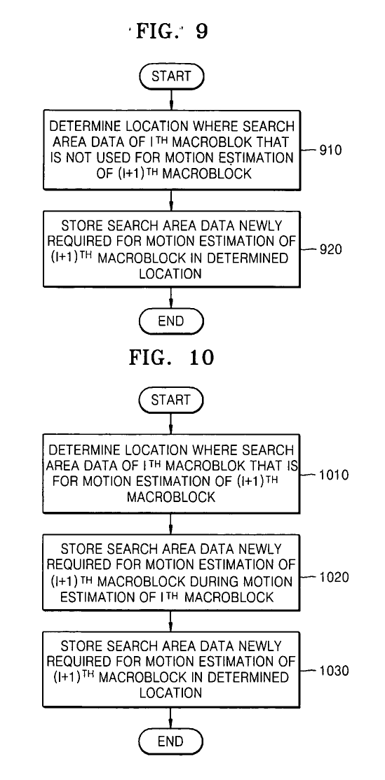

FIG. 9 is a flowchart illustrating a method of storing image data for motion estimation according to an embodiment of the present invention.

Referring to FIG. 9, in operation 910, the controller 250 determines a location where a data unit that is not used for motion estimation of an (i+1)^{th} macroblock, among search area data used for motion estimation of an i^{th} macroblock and stored in the internal memories 211, 212, and 213, is stored.

In operation 920, once the image processing unit 230 completes motion estimation of the i^{th} macroblock, the controller 250 reads a data unit newly required for motion estimation of the (i+1)^{th} macroblock from the external memory 110 and stores the read data unit in the determined location.

FIG. 10 is a flowchart illustrating a method of storing image data for motion estimation according to another exemplary embodiment of the present invention.

Referring to FIG. 10, in operation 1010, the controller 250 determines a location where a data unit that is not used for motion estimation of an (i+1)^{th} macroblock, among search area data used for motion estimation of an i^{th} macroblock and stored in the internal memories 214, 215, and 216, is stored.

In operation 1020, when the image processing unit 230 performs motion estimation on the i^{th} macroblock, the controller 250 performs controlling to read a data unit newly required for motion estimation of the (i+1)^{th} macroblock from the external memory 100 and store the read data unit in the additional internal memory 217.

In operation 1030, once the image processing unit 230 completes motion estimation of the i^{th} macroblock, the controller 250 performs controlling to store the data unit stored in the additional internal memory 100 in the determined location.

As described above, according to the exemplary embodiments of the present invention, it may be possible to reduce the number of internal memories for storing search area data for motion estimation and the number of combination logics for multiplexing search area data stored in each internal memory. Moreover, according to these exemplary embodiments of present invention, the number, of gates used for implementing an internal memory may be reduced and a processing time may be reduced without a change in the size of an internal memory.

The present invention may also be embodied as computer-readable code on a computer-readable recording medium. The computer-readable recording medium is any data storage device that can store data which can be thereafter read by a computer system. Examples of the computer-readable recording medium may include, but is not limited to, read-only memories (ROM), random-access memories (RAM), CD-ROMs, magnetic tapes, floppy disks, optical data storage devices, and carrier waves. The computer-readable recording medium may also be distributed over network coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image data storage device included in a motion estimation device to store image data of a reference frame, the image data storage device comprising:
a data storing unit which stores search area data of the reference frame used for motion estimation of a macroblock; and
a controller which performs controlling to store the search area data in or read the search area data from the data storing unit,
wherein the data storing unit includes at least one internal memory capable of storing a plurality of data units, each data unit being search area data of the reference frame having a size corresponding to a difference between search area data used for motion estimation of an i^{th} (i is an integer) macroblock and search area data used for motion estimation of an (i+1)^{th} macroblock.

2. The image data storage device of claim 1, wherein the controller performs controlling to read search area data used for motion estimation of a current macroblock from an external memory and store the read search area data in predetermined locations of the at least one internal memory.

3. The image data storage device of claim 1, wherein the controller performs controlling to continue storing search area data used for motion estimation of the (i+1)^{th} macroblock and stored in the at least one internal memory among the search area data used for motion estimation of the i^{th} macroblock and store search area data newly required for motion estimation of the (i+1)^{th} macroblock in a location of the at least one internal memory where search area data used for motion estimation of the i^{th} macroblock, which is not used for motion estimation of the (i+1)^{th} macroblock, is stored.

4. The image data storage device of claim 1, wherein the number of internal memories is determined based on the bus access bandwidth of the internal memories and/or the size of search area data.

5. The image data storage device of claim 1, further comprising a data arranging unit which reads the data unit from the at least one internal memory and arranges the read data unit as the search area data used for motion estimation of a current macroblock.

6. The image data storage device of claim 1, wherein the macroblock has a size of 16×16, the search area data has a size of 144×80, and a bus access bandwidth is 128 bits, each of the data units has a size of 16×80.

7. An image data storage device included in a motion estimation device to store image data of a reference frame, the image data storage device comprising:
a data storing unit which stores search area data of the reference frame used for motion estimation of a macroblock; and
a controller which performs controlling to store the search area data in or read the search area data from the data storing unit,
wherein the data storing unit comprises:
at least one internal memory capable of storing a plurality of data units, each data unit being search area data of the reference frame having a size corresponding to a difference between search area data used for motion estimation of an i^{th} (i is an integer) macroblock and search area data used for motion estimation of an (i+1)^{th} macroblock; and
an additional internal memory which stores search area data newly required for motion estimation of the (i+1)^{th} macroblock during motion estimation of the i^{th} macroblock.

8. The image data storage device of claim 7, wherein the controller performs controlling to store the search area data newly required for motion estimation of the (i+1)^{th} macroblock, which is stored in the additional internal memory, in a location of the at least one internal memory where search area data used for motion estimation of the i^{th} macroblock, which is not used for motion estimation of the (i+1)^{th} macroblock, is stored, when there is no access to the internal memories after completion of motion estimation of the i^{th} macroblock.

9. The image data storage device of claim 7, wherein the number of internal memories is determined based on the bus access bandwidth of the internal memories and/or the size of search area data.

10. The image data storage device of claim 7, further comprising a data arranging unit which reads the data unit from the at least one internal memory and arranges the read data unit as the search area data used for motion estimation of a current macroblock.

11. A method of storing image data of a reference frame for motion estimation, the method comprising:
determining a location where search area data used for motion estimation of an i^{th} (i is an integer) macroblock, which is stored in at least one internal memory capable of storing a plurality of data units and is not used for motion estimation of an (i+1)^{th} macroblock, is stored, each data unit being search area data of a reference frame having a size corresponding to a difference between search area data used for motion estimation of the i^{th} macroblock and search area data used for motion estimation of the (i+1)^{th} macroblock; and
storing search area data newly required for motion estimation of the (i+1)^{th} macroblock in the determined location of the at least one internal memory.

12. The method of claim 11, wherein the search area data is read from an external memory and stored in the at least one internal memory.

13. The method of claim 11, wherein search area data used for motion estimation of both the i^{th} macroblock and the (i+1)^{th} macroblock remains stored in the at least one internal memory during the motion estimation of the i^{th} macroblock and the motion estimation of the (i+1)^{th} macroblock.

14. A method of storing image data of a reference frame for motion estimation, the method comprising:
determining a location where search area data used for motion estimation of an i^{th} (i is an integer) macroblock, which is stored in at least one internal memory capable of storing a plurality of data units and is not used for motion estimation of an (i+1)^{th} macroblock, is stored, each data unit being search area data of a reference frame having a size corresponding to a difference between search area data used for motion estimation of the i^{th} macroblock and search area data used for motion estimation of the (i+1)^{th} macroblock;
storing search area data newly required for motion estimation of the (i+1)^{th} macroblock in an additional internal memory during motion estimation of the i^{th} macroblock; and
storing the search area data newly required for motion estimation of the (i+1)^{th} macroblock, which is stored in the additional internal memory, in the determined location of the at least one internal memory after completion of motion estimation of the i^{th} macroblock.

15. The method of claim 14, wherein the search area data is read from an external memory and stored in the at least one internal memory.

16. The method of claim 14, wherein search area data used for motion estimation of both the i^{th} macroblock and the (i+1)^{th} macroblock remains stored in the at least one internal memory during the motion estimation of the i^{th} macroblock and the motion estimation of the (i+1)^{th} macroblock.

17. The image storage device according to claim 7, wherein the search area data newly required comprises search area data not used for the estimation of the i^{th} macroblock.

18. The image storage device according to claim 11, wherein the search area data newly required comprises search area data not used for the estimation of the i^{th} macroblock.

19. The image storage device according to claim 14, wherein the search area data newly required comprises search area data not used for the estimation of the i^{th} macroblock.
